(19) United States
(12) Patent Application Publication
(10) Pub. No.: US 2022/0402764 A1
(43) Pub. Date: Dec. 22, 2022

(54) PRODUCTION OF HIGH PURITY PARTICULATE SILICON CARBIDE BY HYDROCARBON PYROLYSIS

(71) Applicant: SUSTEON INC., Cary, NC (US)

(72) Inventors: Shaojun James ZHOU, Cary, NC (US); Raghubir Prasad Gupta, Durham, NC (US); Cory Elliott Sanderson, Wendall, NC (US); Rouzbeh Jafari, Vaudreuil-Dorion (CA)

(21) Appl. No.: 17/777,044

(22) PCT Filed: Nov. 13, 2020
(86) PCT No.: PCT/US2020/060600

§ 371 Date: May 15, 2022

Related U.S. Application Data
(60) Provisional application No. 62/935,930, filed on Nov. 15, 2019.

(51) Int. Cl. C01B 32/984

(52) U.S. Cl. CPC C01B 32/984; C01P 2006/80

(57) ABSTRACT

A process for production of silicon carbide and hydrogen is described, involving reacting hydrocarbon gas in the presence of silicon particles to form particulate silicon carbide and hydrogen, wherein the silicon particles, in addition to being reactants, also act as a catalyst for the reaction. Apparatus for carrying out such process is also described. The disclosed process and apparatus enable production of particulate silicon carbide at high purity, e.g., 5N (99.999%) and higher purity, as well as high purity hydrogen.

### CROSS-REFERENCE TO RELATED APPLICATION

The benefit under 35 USC § 119 of U.S. Provisional Patent Application 62/935,930 filed Nov. 15, 2019 in the name of Shaojun James Zhou for DIRECT METHANE PYROLYSIS TO HYDROGEN AND SILICON CARBIDE is hereby claimed. The disclosure of U.S. Provisional Patent Application 62/935,930 is hereby incorporated herein by reference, in its entirety, for all purposes.

### FIELD

The present disclosure relates to production of high purity particulate silicon carbide (SiC) and hydrogen, by reaction of hydrocarbon gas in the presence of silicon particles to form high-purity SiC and hydrogen, and to corresponding apparatus and method therefor.

### DESCRIPTION OF THE RELATED ART

Silicon carbide powders are used in a wide variety of applications, and are produced in various grades of purity, with low-grade SiC having purity less than 99%, and high-grade SiC having purity exceeding such value.

Low-grade SiC is conventionally made by reaction of silicon dioxide, in the form of silica or quartz sand particles, with particulate elemental carbon at temperatures on the order of 1800-2000° C., involving the following reactions:

C+SiO₂→SiO+CO

SiO₂+CO→SiO+CO₂

C+CO₂→2CO

SiO+2C→SiC+CO

This overall process is highly endothermic and energy intensive, with a net reaction of

SiO₂+3C→α-SiC+2CO

and a net enthalpy, ΔHᵣₓₙ, of 625.1 kJoules/mole. Silicon carbide was first made by this reaction in an electric arc furnace in 1891. The silicon carbide produced by this process is removed in large chunks growing from the carbon electrode, and then further crushed, grounded, and/or milled to generate various sized particles and powders. Purity of metallurgical grade SiC produced by this process is generally in a range of about 97% to 99%, with the balance being other metals such as aluminum and iron, as well as oxygen and nitrogen resulting from reaction in the presence of air. This low-grade SiC product is primarily sold into four markets: (1) abrasives, e.g., for use in grinding wheels, sandpaper, honing/polishing media, and cutting silicon wafers, (2) ceramics, (3) refractory applications, and (4) steel production.

Although such electric arc furnace SiC production process embodies mature process technology and uses low cost starting materials, the purity of the resulting SiC product is low, the process is energy intensive, and large particle sizes of SiC are produced without particle size control.

High-grade SiC finds applications in the electronics and optical industries, and is commercially produced from low-grade SiC that is treated with heat and chemical reagents to remove impurities. Such processing requires many steps and utilizes harsh chemicals (halogens) that require special safety precautions for materials handling and for the design and operation of process equipment.

It would therefore be a substantial advance in the art to provide a methodology and system for producing high-purity SiC that avoids the aforementioned deficiencies and disadvantages of prior efforts for manufacturing such material.

As another matter of relevant background in the present disclosure, and in the context of global energy requirements, hydrogen is a fuel that is the subject of substantial research, development, and implementation efforts. The technology of hydrogen fuel cells and combustion systems has rapidly advanced, and holds potential for amelioration and ultimately the resolution of problems of environmental degradation associated with hydrocarbon fuels.

Current efforts to generate hydrogen at commodity production levels are increasingly focused on methane pyrolysis, as an alternative to steam methane reforming and water electrolysis, both of which have a number of associated deficiencies. Methane pyrolysis has the advantage of ready availability and low cost of methane, with catalytic cracking of methane producing hydrogen and solid carbon by the following reaction:

CH₄→C₍ₛ₎+2H₂; ΔH_{25° C.}^{o}=74.8 kJ/mol

Stoichiometrically, two moles of hydrogen can be produced for every mole of methane by such reaction, but in practice some of the carbon will be lost in unwanted carbon products, and the actual molar ratio of hydrogen to carbon in this reaction correspondingly will be on the order of about 1.7.

The cost of hydrogen production from the above reaction of catalytic cracking of methane, however, has been estimated to be $7/kg H₂, a cost that is not competitive with conventional steam methane reforming processes. Further, although methane pyrolysis by the above reaction produces carbon-free hydrogen, since only part of the heating value in methane is captured in hydrogen (240 kJ/mol) but not in the carbon, and since energy is consumed to overcome the endothermic heat of reaction (75 kJ/mol methane), only a maximum 45% of the energy in methane is theoretically recoverable as hydrogen. Additionally, the solid carbon produced in the above reaction is generally graphitic carbon having little or no substantial value.

In view of the foregoing circumstances, there is a compelling need for innovative approaches to generating carbon-free hydrogen that are economically competitive, energy-efficient, and environmentally benign. It therefore would also be a substantial advance in the art to provide a process and apparatus for generation of hydrogen meeting these criteria.

### SUMMARY

The present disclosure relates generally to production of high-purity silicon carbide and hydrogen, and more specifically relates in various aspects to reaction of hydrocarbon gases in the presence of particulate silicon to form high-purity silicon carbide and hydrogen, and to process and apparatus therefor, as well as to process and apparatus for carbon-free hydrogen generation.

In one aspect, the disclosure relates to a process for production of silicon carbide and hydrogen, comprising:

reacting hydrocarbon gas in the presence of silicon particles to form particulate silicon carbide and hydrogen gas; and
recovering the particulate silicon carbide.

In another aspect, the disclosure relates to an apparatus for production of silicon carbide, comprising:

a reactor constructed and arranged to receive silicon particles and hydrocarbon gas for reaction of the hydrocarbon gas in the presence of the silicon particles, and to discharge particulate silicon carbide, and hydrogen gas;
a source containing hydrocarbon gas, arranged in supply relationship to the reactor; and a source containing silicon particles, arranged in supply relationship to the reactor;
wherein the apparatus is configured so that in operation thereof hydrocarbon gas is supplied to the reactor from the source containing hydrocarbon gas, and silicon particles are supplied to the reactor from the source containing silicon particles, so that the hydrocarbon gas is reacted in the presence of the silicon particles in a reaction in the reactor, with the discharge of hydrogen gas and particulate silicon carbide from the reactor, as products of the reaction.

Other aspects, features and embodiments of the disclosure will be more fully apparent from the ensuing description and appended claims.

### BRIEF DESCRIPTION OF THE DRAWING

FIG. 1 is a schematic representation of a process system for reaction of methane in the presence of silicon particles to form silicon carbide and hydrogen, according to one embodiment of the present disclosure.

FIG. 2 is a graph showing concentration of methane and hydrogen (purity (%)), and temperature (° C.), as a function of reaction time (minutes), for the reaction of particulate silicon with methane.

FIG. 3 shows x-ray diffraction (XRD) spectra, in arbitrary intensity units as a function of 2-θ (degree), of silicon carbide formed by a reaction of particulate silicon and methane at differing temperature and reaction duration conditions.

FIG. 4 is a process system arrangement employed to assess the catalytic effect of silicon particles on methane reaction resulting in production of hydrogen gas, as compared to methane reaction in the absence of silicon particles.

FIG. 5 is a graph showing the composition of the gases exiting the reactor in the process system of FIG. 4, as a function of time, for methane reaction in the presence (“with Si”) and absence (“blank”) of silicon particles, in which the methane gas contained minor amounts of C₂ (ethane, ethylene) and C₃ hydrocarbon gas components (see graph inset).

### DETAILED DESCRIPTION

The present disclosure relates to production of high-purity silicon carbide particles, and to process and apparatus for such production by reaction of hydrocarbon gases. In various aspects, the disclosure relates to reaction of methane to form high-purity particulate silicon carbide and hydrogen, and to methodology and apparatus for carrying out such reaction.

As used herein and in the appended claims, the singular forms “a”, “and”, and “the” include plural referents unless the context clearly dictates otherwise.

More specifically, the present disclosure relates to reaction of methane, e.g., in the form of natural gas, in the presence of silicon particles to form hydrogen and silicon carbide. The silicon particles, in addition to being reactants, also act as a catalyst for methane reaction, and such particles may be utilized with or without surface treatment.

The process of the present disclosure differs from two-step approaches in which a hydrocarbon is first decomposed into hydrogen and carbon that coats silicon or silicon dioxide (SiO₂) particles, following which the carbon-coated particles are heated to high temperature to form silicon carbide (SiC). Instead, the direct production of hydrogen and silicon carbide is carried out according to the following reaction, when the hydrocarbon gas is methane:

CH₄+Si→SiC+2H₂.

Corresponding reactions are conducted in the use of other hydrocarbon gases, e.g., the following reactions for ethane, and for propane, respectively:

C₂H₆+2Si→2SiC+3H₂

C₃H₈+3Si→3SiC+4H₂.

The process of the present disclosure has a fundamental advantage that each of the silicon particles and the hydrocarbon gas can be individually purified to high levels of purity prior to their reaction with one another, so that extremely high purity particulate silicon carbide can be produced in a single step with desired product properties, and without the need for further purification of the particulate silicon carbide product to accommodate rigorous purity specifications for end-use applications such as ceramics, semiconductors, optoelectronics, and power electronics.

In addition, the overall process of the present disclosure involving reaction of particulate silicon and hydrocarbon gas is nearly thermally neutral, thereby substantially eliminating the external energy requirement for reaction of the hydrocarbon feedstock. As a result, the process can recover up to 60% of the heat value of the hydrocarbon feedstock utilizing hydrocarbon gas such as high-purity methane, a 15% increase compared to conventional methane reaction processes that are carried out at temperatures of up to 1100° C. and generate low value carbon as a co-product of high production cost hydrogen.

The process of the present disclosure produces green, high-purity silicon carbide, and hydrogen, and is highly cost-effective in character. By way of specific example, silicon powder may have a raw material cost in a range of $0.50-$3.00/kg. At a sale price of SiC at $5.00-$7.45/kg for a crude (low-purity) SiC powder and assuming a 100% profit margin, the SiC credit ranges from $4.20 to $7.00/kg. At a hydrogen production cost of about $7/kg by methane reaction, and with 10 kg of silicon carbide produced for every kilogram of hydrogen produced by the process due to the higher molecular weight of SiC in relation to hydrogen, the cost of hydrogen becomes zero at a SiC credit of $0.70/kg SiC, which is 10% of the current market price of green, high-purity SiC.

It therefore is apparent that the process of the present disclosure not only enables the production of high-purity, high-value SiC, but it also provides a hydrogen product that is likewise of high-purity. The hydrogen product can be converted into power/electricity at the SiC production site electrochemically via fuel cells (such as alkaline, phosphoric acid, proton exchange, solid oxide, and the like), or thermally in a gas turbine or in a gas engine. The hydrogen product gas may be packaged at the process facility, such as in high-pressure gas cylinders, or storage and dispensing vessels containing sorbent medium on which the hydrogen may be sorptively stored and subsequently dispensed for use. The sorbent medium for such purpose may for example comprise a physical adsorbent, chemical adsorbent such as metal hydrides, liquid organic hydrogen carrier, metal organic framework (MOF) sorbent, or other sorbent medium of suitable character. The hydrogen product gas may also be used as a fuel gas in the process of the present disclosure, or as a reagent in chemical processes associated with the SiC manufacturing facility. As a further disposition, the hydrogen product gas may be transmitted to a gas pipeline for transport to a desired location of use. Hydrogen may also be blended into a natural gas pipeline for seasonal energy storage, transportation, or use with the mixed natural gas in existing applications, thereby lowering the carbon intensity of those end-uses.

The process of the present disclosure is usefully employed to react particulate silicon and hydrocarbon gas to produce α-SiC and β-SiC at temperatures of from 1000° C. to 2500° C. While such process is primarily described herein with reference to methane as the hydrocarbon gas, as representing a preferred implementation of the present disclosure, it will be recognized that the disclosure is not limited thereto, and that the process of the present disclosure may be advantageously carried out with any of various other hydrocarbon gases, e.g., any one or more selected from the group consisting of C₁-C₄ alkanes (methane, ethane, propane, butane), C₂-C₄ alkenes (ethene, propane, butane), C₂-C₄ alkynes (ethyne, propyne, but-1-yne), etc.

Considering the process of the present disclosure, utilizing high-purity silicon particles and high-purity methane in the reaction

CH₄+Si→SiC+2H₂

to form high-purity SiC and product hydrogen (H₂), the decomposition of methane into carbon and hydrogen is a highly endothermic process. As the temperature is increased to a level at which the decomposition becomes thermodynamically favored (i.e., when ΔG≈0) at −810° K (−537° C.), the heat of reaction remains endothermic (+87 kJoules/mole) and the process is energy intensive, however, the formation of silicon carbide from its elements (Si+C→SiC) is thermodynamically favorable even at ambient room temperature conditions (−25° C.) and is exothermic. By coupling these reactions, the decomposition of methane and formation of silicon carbide together become thermodynamically favorable and the overall reaction is nearly thermally neutral, as shown in Table 1 below, or slightly exothermic, at temperature above 1400° C.

TABLE 1

| | CH₄ | | SiC | | Si + CH₄ → SiC + 2H₂ | |
|---|---|---|---|---|---|---|
| Temperature | ΔH_{f}, | ΔG_{f} | ΔH_{f} | ΔG_{f} | ΔHᵣₓₙ | ΔGᵣₓₙ |
| (° K) | kJ mol⁻¹ | kJ mol⁻¹ | kJ mol⁻¹ | kJ mol⁻¹ | kJ mol⁻¹ | kJ mol⁻¹ |
| 298 (25° C.) | −74.9 | −50.8 | −73.2 | −70.9 | 1.7 | −20.0 |
| 700 (427° C.) | −85.5 | −12.6 | −73.1 | −67.6 | 12.4 | −42.4 |
| 1300 (1027° C.) | −91.9 | 52.7 | −72.7 | −63.0 | 19.2 | −115.7 |
| 1700 (1427° C.) | −92.7 | 97.4 | −123.0 | −59.5 | −30.3 | −156.9 |

The process of the present disclosure thus is suitable to produce high-purity particulate silicon carbide, as for example at purity levels of 99% and higher, with particle size in a range of from 0.1 to 200 μm or larger, at highly advantageous levels of energy intensity. As used herein, percentage purity levels refer to weight percent values of silicon, based on the total weight of the particulate silicon material.

Particulate silicon useful in the process of the present disclosure may be of any suitable high purity and particle size characteristics that in the process reaction produces the desired high-purity silicon carbide. In this respect, particulate silicon at high purity levels is used commercially in the manufacture of polysilicon, photovoltaic cells, and a variety of other manufactured products, and is commercially available at high purity levels, including 4N (99.99%), 4.5N (99.995%), 5N (99.999%), or even higher purity, in a wide variety of particle sizes and particle size distributions.

The particulate silicon material used in the process of the present disclosure may comprise silicon that is upgraded from metallurgical grade silicon, e.g., of 97%-99% purity, by processing to remove impurities therefrom. Processing for impurities removal may for example may be carried out by chemical treatment (for example, acid leaching or solvent refining) and heat treatment (for example, slag refining and directional solidification) of the metallurgical grade silicon. The upgraded metallurgical silicon is typically reformed as a large solid from the purification steps, and therefore is milled and ground again to form particles of appropriate size and morphology.

As another source of silicon particles for the process of the present disclosure, silicon kerf material is produced as a byproduct in silicon wafer manufacturing operations, when ultrapure silicon substrates are sliced to form wafers. As a result of such slicing, carbon residue deriving from slicing lubricants may be present as a contaminant in the silicon kerf material, and such material may be processed by appropriate impurities removal techniques to remove such carbon residue to produce particulate silicon of appropriate purity (e.g., 99%, 99.5%, or higher) for use in the process of the present disclosure.

The purity of the silicon particles in various embodiments may be at least 1N (90%), at least 2N (99%), at least 3N (99.9%), at least 4N (99.99%), or at least 5N (99.999%) purity.

The hydrocarbon gases utilized in the process of the present disclosure are readily commercially available at high purity levels of 4N-5N or higher. In various embodiments, the purity of the hydrocarbon gas may be is at least 1N (90%) purity, at least 2N (99%) purity, at least 3N (99.9%) purity, at least 4N (99.99%) purity, or at least 5N (99.999%) purity.

Using such high-purity particulate silicon and high-purity hydrocarbon gas starting materials, the high-purity silicon carbide product can be made in a single step reaction of the particulate silicon with the hydrocarbon gas, in a reactor of appropriate character. The reactor may be of any suitable type, and may for example, in various embodiments, comprise a packed bed, fluidized bed, or other reactor that is constructed, arranged, and operated to conduct the reaction of the high-purity silicon particles with the high-purity hydrocarbon gas to produce high-purity silicon carbide of the desired crystal form, e.g., high-purity α-SiC or high-purity β-SiC.

The reactor may be operated at any suitable process conditions of temperature, pressure, flow rate, etc. that achieve the desired high-purity silicon carbide product. For example, the reactor may be operated at temperatures in a range of from 500° C. to 2400° C., 700° C. to 2400° C., 1000° C. to 2400° C., or other suitable range, although the disclosure is not limited thereto. In various embodiments, the high-purity particulate silicon (silicon powder) may be heated to temperature below the silicon melting point (1414° C.), preferably less than 1400° C., and more preferably less than 1300° C. to prevent silicon powder melting and/or agglomeration, and reacted with the carbon produced by reaction of the hydrocarbon gas to form β-SiC. The β-SiC thus formed can then be converted, if desired, into α-SiC at appropriate temperature, e.g., in a range of from 1800° C. to 2500° C. For example, the reactor may be constructed, arranged, and operated to provide a temperature gradient in the reactor so that β-SiC is formed in a first zone of the reactor at temperature of at least 1000° C. but below the silicon melting point temperature of 1414° C., with the β-SiC then being heated in a second zone of the reactor to temperature in the aforementioned range of from 1800° C. to 2400° C. An increasing temperature progression may be provided in the second zone of the reactor, so that the β-SiC is heated from a temperature of 2100° C. at which β-SiC begins to slowly convert monotropically to α-SiC to a temperature of 2400° C. at which α-SiC is formed rapidly and completely.

In the reactor, the reaction is advantageously carried out so that the starting particulate silicon is never melted, so that the starting silicon particle size is preserved. The particulate silicon carbide product and the byproduct hydrogen gas may be discharged together from the reactor and passed to a gas/solids separator, such as a cyclone separator, filter, baghouse, or the like, or the reactor may be constituted to separately discharge the particulate silicon carbide product and byproduct hydrogen gas from the reactor, e.g., with the byproduct hydrogen gas being discharged as an overhead gas effluent and the particulate silicon carbide product being discharged gravitationally or otherwise from the reactor vessel.

It will be appreciated that the reaction of the particulate silicon and hydrocarbon gas to form the product particulate silicon carbide and byproduct hydrogen may be carried out as a continuous process, or alternatively as a batch process or a semi-batch process. It will also be appreciated that the reaction, although susceptible of being carried out in a single reactor, with an appropriate temperature condition or conditions (e.g., a thermal progression to provide an appropriate temperature gradient or profile in the reactor), may also be carried out in multiple reactors, such as a first reactor vessel in which the Si particles and hydrocarbon gas are reacted to form particulate β-SiC, and a second reactor vessel in which the β-SiC is further thermally processed to form particulate α-SiC final product.

In one possible configuration of a batch reactor, the reactor may be constructed, arranged, and operated to carry out the silicon carbide manufacturing process as a two-step process. The first step may involve reaction of Si powder with hydrocarbon gas at pressures in a range of from 1 to 60 bar and temperatures in a range of from 500° C. to 1,100° C. The reactor may be loaded with Si particles, with particle size in a range of from 0.1 μm to 200 μm, and flushed with argon or any suitable inert gas (with respect to SiC and H₂ formation) to remove all nitrogen and oxygen from the reactor to avoid forming undesirable side products. The reactor may be sealed and heated to the target temperature (500° C.-1,100° C.). Heating can be carried out in any suitable manner, e.g., using induction, microwave, or electrical heaters, or heaters of other suitable types. The reactor may be maintained at the target temperature for a predetermined time (e.g., a time in the range of from 10 to 300 seconds) to effect initial heating of the reactor and its contents. At the end of the first step, the reactor may be depressurized, with the pressure being released by opening a pressure control valve in a discharge line communicating with the interior volume of the reactor. Filters may be placed at the exit of the reactor, upstream of the discharge line, in order to minimize and preferably to prevent losses of carbon, Si, and SiC particles entrained in the released gas stream. In the second step of the two-step process, the temperature is increased to a temperature in the range of from 1200° C. to 1500° C. Heating can be carried out using an electrical, microwave, or induction heater, or a heater of any other suitable type. The reactor then is maintained at the target temperature for a predetermined time (e.g., a time in the range of from 15 to 720 minutes). At the end of the second step of the two-step process, the batch reactor system is cooled down, and the product is removed. The reactor in the batch reactor system may be configured, arranged, and operated in any suitable manner effective to carry out the process of the present disclosure and produce silicon carbide product, and byproduct hydrogen. For example, the batch reactor may be equipped with a mechanical agitation device or other stirring or mixing device, or the batch reactor may be configured as a rotating vessel equipped with a mechanical agitation device or other stirring or mixing device, to increase solid mixing and control agglomeration. In specific implementations, the reactor may comprise a rotary kiln or a rotary autoclave style reactor.

Alternatively, the process system may be constructed, arranged, and operated to carry out the process of the present disclosure as a continuous process, e.g., a two-step continuous process. In both of the first and second steps of such continuous process, heating may be carried out using induction, electrical heating, or microwave heaters, or heaters of other types. In the first step, Si particles, e.g., with particle size in a range of from 0.1 μm to 200 μm, and hydrocarbon gases enter the reactor to undergo reaction at appropriate elevated temperature (such as temperature in a range of from 500° C. to 1100° C.). The reactor can be of any suitable type, including, for example, a rotary kiln bed, fluidized bed, downdraft moving bed, cyclone reactor, or rotating fluidized bed with stationary geometry. The solids (including Si, C, and SiC) is discharged from a bottom or lower portion of the reactor, and gas (including hydrogen and light hydrocarbons) is discharged from a top or upper portion of the reactor. As described hereinabove, filters can be installed at the reactor gas outlet to minimize and preferably prevent loss of solid particles. The solid product of the first step that is discharged from the first step reactor then enters the second step reactor. The second step reactor can be of any suitable type and can for example comprise a rotating bed including anti-agglomeration elements or devices configured and arranged to prevent agglomeration, such as ultrasound generators, vibratory mechanical assemblies, mechanical mixers, etc., for enhancing solid-solid mixing in the reactor. Suitable anti-agglomeration elements may include elements that effect in-situ size reduction of solid particles in the reactor, such as for example ceramic balls or other balls which are inert and stable at reactor temperatures, and which in interaction with the silicon particles in the reactor help to remove potential passivating films or other passive layers on the surfaces of silicon particles so that the rate of reaction in the reactor is thereby enhanced. In various embodiments, the anti-agglomeration elements may comprise silicon carbide ceramic balls of appropriate size, which being of the same or similar silicon carbide composition as the reaction final product will not adversely affect the reaction

Although silicon particles used for formation of particulate silicon carbide in the process of the present disclosure have illustratively been described in specific implementations as having a particle size in a range of from 0.1 μm to 200 μm, it will be recognized that the disclosure is not limited thereto, and that the silicon particles employed in the broad practice of the present disclosure may be of any suitable size and size distribution. For example, silicon particles in various embodiments may have a size in a range of from 0.1 μm to 1 mm, or higher. In other embodiments, the silicon particles may have a size in a range of from 1 μm to 10 μm, or in a range of from 10 μm to 100 μm, or in a range of from 100 μm to 1 mm. In still other embodiments, the silicon particles may have a size and range of from 0.1 μm to 200 μm.

As used in such context, the size of the silicon particles refers to their diameter or (in the case of particles having some degree of eccentricity) equivalent diameter, and reference to a range of sizes means that the average particle size of the silicon particles in the corresponding mass, amount, or lot of the silicon particles is an particle size value that is in the specified range. Preferably, such ranges of silicon particle size, in addition to their application to encompassing average particle size of the corresponding mass, amount, or lot of the silicon particles, also characterize the particle size distribution of the corresponding mass, amount, or lot of the silicon particles, as having a major portion (e.g., at least 50%, 55%, 60%, 65%, 70%, 75%, 80%, 85%, 90%, 95%, or higher) of the silicon particles therein being particles with particle sizes in the specified range of particle sizes. For example, a particular lot of silicon particles utilized in the reaction to produce particulate silicon carbide may have an average particle size in the range of from 10 μm to 100 μm, where the average particle size is 0.47 μm, and at least 85% of particles in the particular lot having particle sizes in such range of from 10 μm to 100 μm. As mentioned, the process of the present disclosure is not limited to a specific size or size distribution of silicon particles, and specific average particle size and particle size distribution can be readily selected by those of ordinary skill in the art based on the disclosure herein, in specific implementations and applications of the present disclosure.

The process of the present disclosure correspondingly achieves a major advance in the art of SiC production, which may be efficiently scaled for commercial production of particulate SiC, as well as production of byproduct hydrogen, either in a distributed production facility or in a large centralized facility.

The particulate silicon carbide production process in accordance with the present disclosure has many advantages, including the following: (1) the process may be carried out in a single reactor/single step implementation, of relatively simple and straightforward design and operation; (2) SiC production utilizing hydrocarbon gas reaction overall approaches thermal neutrality and moderate energy intensity in the formation of the SiC product; (3) the process is simpler, easier to control, and more energy-efficient than prior art methods for SiC production; (4) the process capitalizes on the high reactivity of nascent carbon and partially decomposed hydrocarbon gas fragments, and these species are much more reactive with silicon than graphitic carbon, thereby enhancing the SiC formation kinetics and increasing the process throughput; (5) the process produces high-purity SiC having a higher market value than SiC produced by conventional methods of reacting SiO₂ with carbon, such as carbon black derived from petroleum coke; (6) the process produces high-value SiC having an established large market; (7) the process produces SiC with controlled particle size that is the same or nearly the same as the starting silicon powder; and (8) the process is characterized by extremely low greenhouse gas emissions.

Thus, in one aspect, the present disclosure relates to a process for production of silicon carbide and hydrogen, comprising:

reacting hydrocarbon gas in the presence of silicon particles to generate particulate silicon carbide, and hydrogen gas; and
recovering the particulate silicon carbide.

The hydrocarbon gas may comprise any one or more gas selected from the group consisting of C₁-C₄ alkanes, C₂-C₄ alkenes, and C2-C4 alkynes, e.g., any one or more gas selected from the group consisting of methane, ethane, propane, butane, ethene, propane, butane, ethyne, propyne, and but-1-yne. In various embodiments, the hydrocarbon gas may comprise methane. The purity of the hydrocarbon gas may for example be at least 4N (99.99%) purity, at least 4.5N (99.995%) purity, or at least 5N (99.999%) purity.

In such process, methane may be provided to the process as natural gas. The natural gas may be treated to remove sulfur-containing components therefrom, such as by contacting the natural gas with an amine solution or solution of caustic soda. Alternatively, the treatment of the natural gas to remove sulfur-containing components therefrom may comprise contacting the natural gas with a sorbent medium effective to sorb the sulfur-containing components. The sorbent medium utilized for such purpose may comprise a physical adsorbent, and/or a chemisorbent.

Methane may be provided to the process as renewable natural gas. The renewable natural gas may be obtained from biogas sources such as activated sludge digesters in wastewater treatment systems, animal waste anaerobic processing systems at stockyards and feedlots, or other waste gas sources. Contaminants such as sulfur, carbon dioxide, and other compounds found in these sources may be removed prior to introduction of the feedstock renewable natural gas into the reactor, using standard methane upgrading processes.

The process in specific implementations thus may be conducted, with the hydrocarbon gas, regardless of source, being purified of contaminants prior to the reacting, if necessary or desirable.

The reacting may be conducted in various embodiments in a reactor to which the hydrocarbon gas and silicon particles are supplied, e.g., with the hydrocarbon gas being supplied to a lower portion of the reactor, for upflow through an interior volume of the reactor, and/or in which the silicon particles are supplied to the reactor at an upper portion thereof for downflow through the interior volume of the reactor.

The process in various other embodiments may be conducted with the silicon particles being fluidized in the reactor by the hydrocarbon gas in the interior volume of the reactor.

The process may be conducted in still other embodiments with the silicon particles being introduced into the reactor at one end, with the reactor being oriented at an angle that is appropriate for the amount of silicon particles being introduced, with the reactor being rotated about its central longitudinal axis at a rotational speed that is appropriate for the reaction rate, and with the hydrocarbon gas being introduced at an opposite end of the reactor so that the silicon particles and hydrocarbon gas are reacted to form silicon carbide and hydrogen gas, with discharge of the silicon carbide and hydrogen gas from the reactor. The reactor may be configured for such operation, so that the silicon particles are introduced to the elevated first end of the rotating reactor, and gravitationally move during the reaction to the lower second end of the reactor at which the corresponding particulate silicon carbide reaction product exits the reactor, with the hydrocarbon gas being introduced at the lower second end of the reactor for flow therethrough for reaction and discharge of the resulting product hydrogen gas at the elevated first end of the reactor, similar to the operation of a rotary kiln. The reactor may therefore be of cylindrical form, with appropriately configured reactant inlet and product outlet ports and flow circuitry. Other rotating reactor flow arrangements may be employed with respect to transport, introduction, and discharge of reactants and reaction products. The rotary reactor may be arranged horizontally, with the silicon particles being charged to the rotary reactor in a batch, semi-batch, or continuous operation.

In various embodiments, the reacting may be carried out at temperature in a range of from 250° C. to 1600° C., or in a range of from 350° C. to 1100° C., or in a range of from 500° C. to 900° C., or in a range in which the lower end point of the range and the upper end point of the range are selected from among the following temperature values, wherein the upper end point of the range is higher than the lower end point of the range: 250° C., 255° C., 260° C., 265° C., 270° C., 275° C., 280° C., 285° C., 290° C., 295° C., 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., 475° C., 480° C., 485° C., 490° C., 495° C., 500° C., 505° C., 510° C., 515° C., 520° C., 525° C., 530° C., 535° C., 540° C., 545° C., 550° C., 555° C., 560° C., 565° C., 570° C., 575° C., 580° C., 585° C., 590° C., 595° C., 600° C., 605° C., 610° C., 615° C., 620° C., 625° C., 630° C., 635° C., 640° C., 645° C., 650° C., 655° C., 660° C., 665° C., 670° C., 675° C., 680° C., 685° C., 690° C., 695° C., 700° C., 705° C., 710° C., 715° C., 720° C., 725° C., 730° C., 735° C., 740° C., 745° C., 750° C., 755° C., 760° C., 765° C., 770° C., 775° C., 780° C., 785° C., 790° C., 795° C., 800° C., 805° C., 810° C., 815° C., 820° C., 825° C., 830° C., 835° C., 840° C., 845° C., 850° C., 855° C., 860° C., 865° C., 870° C., 875° C., 880° C., 885° C., 890° C., 895° C., 900° C., 905° C., 910° C., 915° C., 920° C., 925° C., 930° C., 935° C., 940° C., 945° C., 950° C., 955° C., 960° C., 965° C., 970° C., 975° C., 980° C., 985° C., 990° C., 995° C., 1000° C., 1005° C., 1010° C., 1015° C., 1020° C., 1025° C., 1030° C., 1035° C., 1040° C., 1045° C., 1050° C., 1055° C., 1060° C., 1065° C., 1070° C., 1075° C., 1080° C., 1085° C., 1090° C., 1095° C., 1100° C., 1105° C., 1110° C., 1115° C., 1120° C., 1125° C., 1130° C., 1135° C., 1140° C., 1145° C., 1150° C., 1155° C., 1160° C., 1165° C., 1170° C., 1175° C., 1180° C., 1185° C., 1190° C., 1195° C., 1200° C., 1205° C., 1210° C., 1215° C., 1220° C., 1225° C., 1230° C., 1235° C., 1240° C., 1245° C., 1250° C., 1255° C., 1260° C., 1265° C., 1270° C., 1275° C., 1280° C., 1285° C., 1290° C., 1295° C., 1300° C., 1305° C., 1310° C., 1315° C., 1320° C., 1325° C., 1330° C., 1335° C., 1340° C., 1345° C., 1350° C., 1355° C., 1360° C., 1365° C., 1370° C., 1375° C., 1380° C., 1385° C., 1390° C., 1395° C., 1400° C., 1405° C., 1410° C., 1415° C., 1420° C., 1425° C., 1430° C., 1435° C., 1440° C., 1445° C., 1450° C., 1455° C., 1460° C., 1465° C., 1470° C., 1475° C., 1480° C., 1485° C., 1490° C., 1495° C., 1500° C., 1505° C., 1510° C., 1515° C., 1520° C., 1525° C., 1530° C., 1535° C., 1540° C., 1545° C., 1550° C., 1555° C., 1560° C., 1565° C., 1570° C., 1575° C., 1580° C., 1585° C., 1590° C., 1595° C., and 1600° C.

The process may further comprise packaging the hydrogen gas. The process may comprise purifying the hydrogen gas to remove contaminants therefrom, e.g., wherein the purifying comprises at least one selected from the group consisting of membrane purification, physical adsorbent purification, electrochemical purification, and chemisorbent purification. The purifying may for example comprise dry scrubbing of the recovered hydrogen gas. When electrochemical purification is utilized, a solid-state compressor apparatus of the type described in International Publication WO 2020/016153 A1 may be employed, including a compressor cell stack including at least one compressor cell having a membrane electrode assembly sandwiched between two cell plates.

The process may be conducted wherein the hydrocarbon gas and/or the silicon particles are heated prior to the reacting. The reacting may be carried out in a heated reactor. The process may further comprise recovering heat from the hydrogen gas and/or particulate silicon carbide, and may comprise heating the hydrocarbon gas and/or silicon particles with the recovered heat from the hydrogen gas and/or particulate silicon carbide.

The separation of the hydrogen gas and particulate silicon carbide, to recover hydrogen, and to recover the particulate silicon carbide, may comprise separately discharging the hydrogen gas and particulate silicon carbide from a reactor in which the reacting is carried out. The process may be carried out in which the separation of the hydrogen gas and particulate silicon carbide to recover hydrogen product, and to recover particulate silicon carbide, comprises solid/gas separation in a cyclone separator and/or in a filter.

The final purity of the SiC product is partially determined by the conversion of Si+C to SiC. In order to achieve full conversion of all Si particle, hydrocarbon gas in excess of the stoichiometric amount may be introduced into the reactor. Therefore, recovery of the particulate SiC may comprise discharging the SiC and excess carbon mixture to a separation device. Any suitable means may be used for separating SiC and carbon particles including classification, electrostatic separation, magnetic separation, and the like. The carbon product may have a value depending upon its physical and chemical properties. The purity of each of the SiC and the H₂ produced in the reaction may in particular embodiments be at least 1N (90%) purity, at least 2N (99%) purity, at least 3N (99.9%) purity, at least 4N (99.99%) purity, or at least 5N (99.999%) purity.

In the process, the reacting may be carried out in the presence of a catalyst augmenting the catalyst effect of the silicon particles. The catalyst may comprise a transition metal or metals, such as nickel, or iron, or the catalyst may comprise alkali metal such as sodium.

In another aspect, the disclosure relates to an apparatus for production of silicon carbide, comprising:
a reactor constructed and arranged to receive silicon particles and hydrocarbon gas for reaction of the hydrocarbon gas in the presence of the silicon particles, and to discharge particulate silicon carbide, and hydrogen gas;
a source containing hydrocarbon gas, arranged in supply relationship to the reactor; and a source containing silicon particles, arranged in supply relationship to the reactor;
wherein the apparatus is configured so that in operation thereof hydrocarbon gas is supplied to the reactor from the source containing hydrocarbon gas, and silicon particles are supplied to the reactor from the source containing silicon particles, so that the hydrocarbon gas is reacted in the presence of the silicon particles in a reaction in the reactor, with the discharge of hydrogen gas and particulate silicon carbide from the reactor, as products of the reaction.

The apparatus may be configured with the source containing hydrocarbon gas comprising a fixedly positioned supply vessel, a tube trailer, or a gas pipeline. The hydrocarbon gas in various embodiments may be or comprise methane. In other embodiments, the hydrocarbon gas may be or comprise natural gas.

The apparatus may further comprise a contaminant removal unit constructed and arranged to remove one or more contaminants from the hydrocarbon gas supplied from the source containing hydrocarbon gas to the reactor. Such contaminant removal unit may comprise an absorption or wet scrubber apparatus, or it may comprise one or more vessels containing physical adsorbent and/or chemisorbent selective for said one or more contaminants. In a specific implementation, the contaminant removal unit may comprise multiple vessels constructed and arranged for continuous on stream operation, wherein one or more of such vessels is in an on-stream contaminant removal phase of operation, while another or others of such vessels are regenerated or on standby after regeneration, to subsequently resume on-stream contaminant removal operation, so that each of said vessels goes through cyclic on-stream and regeneration operations during production of the particulate silicon carbide and the hydrogen gas by the apparatus. The multiple vessels may be constructed and arranged for cyclic operation involving pressure swing adsorption and/or temperature swing adsorption.

The apparatus may be constituted with methane in the hydrocarbon gas source, e.g., methane comprised in natural gas in such source.

The apparatus in various embodiments may be constructed and arranged so that hydrocarbon gas is supplied to the reactor from the source containing hydrocarbon gas, e.g., at a lower portion of the reactor, for upflow through an interior volume of the reactor, and/or with silicon particles supplied to the reactor at an upper portion thereof for downflow through the interior volume of the reactor.

The apparatus in other embodiments may be configured so that the silicon particles are fluidized in the reactor by the hydrocarbon gas in the interior volume of the reactor.

The apparatus in still other embodiments may be configured, with the reactor being oriented at an angle that is appropriate for the amount of silicon particles being introduced, with the reactor being rotated about its central longitudinal axis at a rotational speed that is appropriate for the reaction rate, and with the hydrocarbon gas being introduced at an opposite end of the reactor so that the silicon particles and hydrocarbon gas are reacted to form silicon carbide and hydrogen gas, with discharge of the silicon carbide and hydrogen gas from the reactor. The reactor may be configured for such operation, so that the silicon particles are introduced to the elevated first end of the rotating reactor, and gravitationally move during the reaction to the lower second end of the reactor at which the corresponding particulate silicon carbide reaction product exits the reactor, with the hydrocarbon gas being introduced at the lower second end of the reactor for flow therethrough for reaction and discharge of the resulting product hydrogen gas at the elevated first end of the reactor, similar to the operation of a rotary kiln. The reactor may therefore be of cylindrical form, with appropriately configured reactant inlet and product outlet ports and flow circuitry. Other rotating reactor flow arrangements may be employed with respect to transport, introduction, and discharge of reactants and reaction products.

The apparatus may be constructed and arranged so that the reaction is carried out at temperature in a range of from 250° C. to 1600° C., or in a range of from 350° C. to 1100° C., or in a range of from 500° C. to 900° C., or in a range in which the lower end point of the range and the upper end point of the range are selected from among the following temperature values, wherein the upper end point of the range is higher than the lower end point of the range: 250° C., 255° C., 260° C., 265° C., 270° C., 275° C., 280° C., 285° C., 290° C., 295° C., 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., 475° C., 480° C., 485° C., 490° C., 495° C., 500° C., 505° C., 510° C., 515° C., 520° C., 525° C., 530° C., 535° C., 540° C., 545° C., 550° C., 555° C., 560° C., 565° C., 570° C., 575° C., 580° C., 585° C., 590° C., 595° C., 600° C., 605° C., 610° C., 615° C., 620° C., 625° C., 630° C., 635° C., 640° C., 645° C., 650° C., 655° C., 660° C., 665° C., 670° C., 675° C., 680° C., 685° C., 690° C., 695° C., 700° C., 705° C., 710° C., 715° C., 720° C., 725° C., 730° C., 735° C., 740° C., 745° C., 750° C., 755° C., 760° C., 765° C., 770° C., 775° C., 780° C., 785° C., 790° C., 795° C., 800° C., 805° C., 810° C., 815° C., 820° C., 825° C., 830° C., 835° C., 840° C., 845° C., 850° C., 855° C., 860° C., 865° C., 870° C., 875° C., 880° C., 885° C., 890° C., 895° C., 900° C., 905° C., 910° C., 915° C., 920° C., 925° C., 930° C., 935° C., 940° C., 945° C., 950° C., 955° C., 960° C., 965° C., 970° C., 975° C., 980° C., 985° C., 990° C., 995° C., 1000° C., 1005° C., 1010° C., 1015° C., 1020° C., 1025° C., 1030° C., 1035° C., 1040° C., 1045° C., 1050° C., 1055° C., 1060° C., 1065° C., 1070° C., 1075° C., 1080° C., 1085° C., 1090° C., 1095° C., 1100° C., 1105° C., 1110° C., 1115° C., 1120° C., 1125° C., 1130° C., 1135° C., 1140° C., 1145° C., 1150° C., 1155° C., 1160° C., 1165° C., 1170° C., 1175° C., 1180° C., 1185° C., 1190° C., 1195° C., 1200° C., 1205° C., 1210° C., 1215° C., 1220° C., 1225° C., 1230° C., 1235° C., 1240° C., 1245° C., 1250° C., 1255° C., 1260° C., 1265° C., 1270° C., 1275° C., 1280° C., 1285° C., 1290° C., 1295° C., 1300° C., 1305° C., 1310° C., 1315° C., 1320° C., 1325° C., 1330° C., 1335° C., 1340° C., 1345° C., 1350° C., 1355° C., 1360° C., 1365° C., 1370° C., 1375° C., 1380° C., 1385° C., 1390° C., 1395° C., 1400° C., 1405° C., 1410° C., 1415° C., 1420° C., 1425° C., 1430° C., 1435° C., 1440° C., 1445° C., 1450° C., 1455° C., 1460° C., 1465° C., 1470° C., 1475° C., 1480° C., 1485° C., 1490° C., 1495° C., 1500° C., 1505° C., 1510° C., 1515° C., 1520° C., 1525° C., 1530° C., 1535° C., 1540° C., 1545° C., 1550° C., 1555° C., 1560° C., 1565° C., 1570° C., 1575° C., 1580° C., 1585° C., 1590° C., 1595° C., and 1600° C.

The apparatus may be configured with the reactor being heated, e.g., by internally disposed heating elements, or by thermal jacketing of the reactor, or by using resistance heating using electricity, or by using inductive heating using electricity, or by microwave heating using electricity, or by using other appropriate heater equipment and heating modalities.

The apparatus in various embodiments may be constituted as further comprising a hydrogen purification unit constructed and arranged to remove one or more contaminants from the hydrogen gas discharged from the reactor, e.g., wherein the hydrogen purification unit is constructed and arranged for at least one of membrane purification, physical adsorbent purification, and chemisorbent purification of the hydrogen gas discharged from the reactor. The hydrogen purification unit may for example comprise a dry scrubber apparatus for purification of the hydrogen gas discharged from the reactor. As discussed hereinabove, electrochemical hydrogen purification may also be utilized, to produce a product hydrogen gas of desired purity.

The apparatus may further comprise a heater constructed and arranged to heat the hydrocarbon gas and/or the silicon particles before entering the reactor. The apparatus may comprise a heat exchanger constructed and arranged to recover heat from the hydrogen gas and/or particulate silicon carbide discharged from the reactor. Such heat exchanger may be constructed and arranged to heat the hydrocarbon gas and/or silicon particles before entering the reactor.

The apparatus in various embodiments and additional implementations may further comprise a solid/gas separator constructed and arranged to remove particulate silicon carbide from hydrogen gas discharged from the reactor, e.g., a cyclone separator and/or a filter. The apparatus may further comprise a source containing catalyst arranged in supply relationship to the reactor, so that the reaction is carried out in the reactor, in the presence of the catalyst, in the operation of the apparatus. The catalyst may comprise a transition metal or metals, e.g., nickel, iron, or other transition metal, or the catalyst may comprise alkali metal such as sodium.

The above-described process and apparatus of the present disclosure are susceptible to implementation in a wide variety of configurations and adaptations, and such process and apparatus are readily scalable in application to high-volume commercial production of hydrogen.

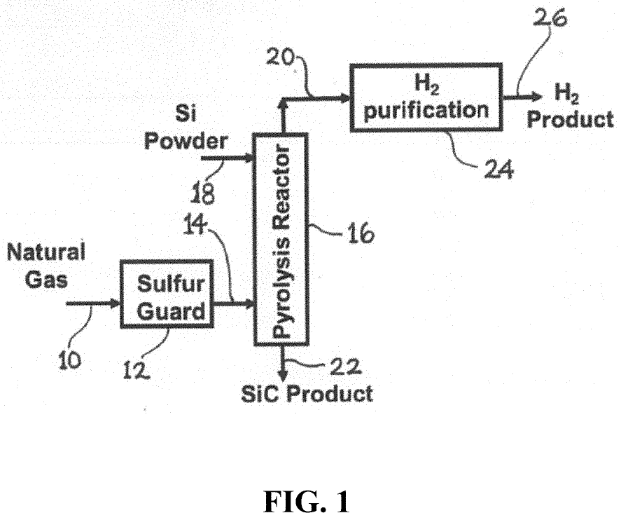

FIG. 1 is a schematic representation of a process system for reaction of methane to form silicon carbide and hydrogen, according to one embodiment of the present disclosure.

In the FIG. 1 process system, a source of methane, e.g., natural gas (“Natural Gas”) is provided, which may be a fixedly positioned supply vessel, tube trailer, gas pipeline or other suitable source structure constructed and arranged to supply the methane gas feedstock to the methane gas inlet line 10. The methane gas feedstock from methane gas inlet line 10 flows to the sulfur guard unit 12, which is optionally included in the process system when the methane feedstock contains sulfur components, such as mercaptans, sulfides, thiols, etc.

The sulfur guard unit 12 when present may be of any suitable type, and may for example comprise an absorption or wet scrubber apparatus in which the methane gas feedstock is contacted with an amine solution or a solution of caustic soda to remove sulfur-containing contaminants of the methane gas feedstock and produce a corresponding sulfur contaminant-reduced methane gas feedstock depleted in such sulfur-containing contaminants. Alternatively, the sulfur guard unit may comprise a vessel, or multiplicity of vessels, containing a volume of physical adsorbent and/or chemisorbent selective for the sulfur-containing contaminants of the methane gas feedstock, through which the methane gas feedstock is flowed for removal of the sulfur-containing contaminants. When multiple vessels are provided containing physical adsorbent for contacting with the methane gas feedstock to remove sulfur-containing contaminants thereof, the vessels may be valvably interconnected for operation with one or more of such vessels being in an on-stream active sulfur contaminant removal phase of operation, while another or others of such vessels are regenerated or on standby after regeneration, to subsequently resume on-stream adsorption operation, in a cyclic operation involving pressure swing adsorption (PSA), temperature swing adsorption (TSA), or a combination of PSA and TSA operations.

Although denominated as a sulfur guard unit, the sulfur guard unit 12 may alternatively or additionally be a contaminant removal unit 12 that is constructed and arranged to remove other unwanted or contaminant component(s) of the raw methane gas feedstock, in addition or alternatively to sulfur-containing contaminants, to provide methane gas feedstock of desired methane purity for subsequent processing.

From the sulfur guard unit (contaminant removal unit) 12, the methane gas feedstock depleted in sulfur-containing contaminants and/or other contaminant components is discharged in purified methane supply line 14 and flows into the reactor 16, for upflow in the interior volume of the reactor for contacting with silicon powder introduced to the reactor in silicon powder supply line 18 from a source of silicon powder (“Si Powder”). The source of silicon powder may be of any suitable type, and may for example comprise a silicon powder supply vessel arranged for gravitational feeding of silicon powder through the silicon powder supply line 18, or a supply hopper containing silicon powder and dispensing the powder into a carrier gas stream flowed in silicon powder supply line 18 to the interior volume of the reactor 16 for delivery of the silicon powder for reaction with the methane gas feedstock to produce hydrogen gas and silicon carbide as reaction products. The silicon powder preferably is introduced at an upper portion of the reactor, as shown in FIG. 1 so that the silicon powder falls downwardly in the interior volume of the reactor, in contact with the methane gas feedstock that is correspondingly introduced at a lower portion of the reactor, as shown, for upflow through the reactor volume.

It will be appreciated that the particle size and particle size distribution of the silicon powder that is introduced in silicon powder supply line 18 may be selected, in relation to the volumetric flow rate of the upflowing methane gas feedstock, to provide a flow velocity of the upflowing methane gas feedstock that provides a suitable residence time for the upflowing methane gas feedstock and silicon particles to accommodate the reaction in the particular reactor.

Alternatively, instead of a countercurrent flow of upflowing methane gas feedstock and downflowing silicon particles, the reactor may be operated as a fluidized bed, in which the introduced silicon powder is fluidized in the methane gas feedstock and reaction gases to provide the appropriate residence time for the reaction, by appropriate selection of the reactor vessel size, volume, cross-sectional area, volumetric flow rate and superficial velocity of the methane gas feedstock, and silicon powder size characteristics and feed rate, and other structural and operating variables.

As a still further alternative, the reactor may be arranged as a conveyor belt reactor (or other moving bed reactor) in which the silicon powder is mechanically advanced through the reactor on the conveyor belt top surface and the methane gas feedstock is flowed through the reactor for contact with the supported silicon powder particles.

As yet another alternative, the reactor may comprise a fixed bed reactor containing a bed of silicon powder in an interior volume of the reactor through which methane gas is flowed to carry out the reaction operation in the reactor. In such fixed bed system, the system may be constructed and arranged for upflow contacting of methane with the bed of silicon powder in the reactor, or the system may be constructed and arranged for downflow contacting of methane with the bed of silicon powder in the reactor. In the design and operation of a fixed bed reactor, the expansion of the fixed bed due to density and molecular weight changes in the solid particles, from the reaction of silicon (28 g/mole) to form silicon carbide (40 g/mole), must be taken into account.

In various embodiments, the system including the reactor may be operated with the amount of silicon particles in the reaction being in a full stoichiometric amount in relation to the amount of hydrocarbon gas in the reaction. In other embodiments, the system including the reactor may be operated with the amount of silicon particles in the reaction being less than a full stoichiometric amount in relation to the amount of hydrocarbon gas in the reaction. In such respect, the relative stoichiometric amounts of the hydrocarbon gas and silicon particles in the reaction may be varied in the broad practice of the process and system of the present disclosure, to provide a desired reaction and corresponding production of reaction products.

It will correspondingly be appreciated that the reactor can be variously configured and operated to effect the desired reaction between the hydrocarbon gas feedstock and silicon particles.

The reaction between the hydrocarbon gas feedstock and the silicon particles to yield silicon carbide and hydrogen may be carried out at any suitable reaction conditions enabling such reaction, of temperature, pressure, feed/flow rates, etc. Although the reaction of hydrocarbon gas and silicon particles to produce silicon carbide and hydrogen is thermodynamically favorable at room temperature, higher temperatures are desirably utilized in order to take advantage of increased reaction kinetics at temperature of 250° C. and higher. In general, the reaction may be carried out at any appropriate temperature, and in various embodiments may be conducted at temperature in a range of from 250° C. to 1600° C., or in other suitable range. In commercial production of hydrogen by the process of the present disclosure, it is advantageous to conduct the reaction at elevated temperatures on the order of 350° C. to 1100° C., and more specifically in a range of from 500° C. to 900° C. in order to achieve suitable reaction kinetics for high-volume silicon carbide and hydrogen production.

More generally, the reaction can be carried out at temperature in a range in which the lower end point of the range and the upper end point of the range are selected from among the following temperature values, wherein the upper end point of the range is higher than the lower end point of the range: 250° C., 255° C., 260° C., 265° C., 270° C., 275° C., 280° C., 285° C., 290° C., 295° C., 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., 475° C., 480° C., 485° C., 490° C., 495° C., 500° C., 505° C., 510° C., 515° C., 520° C., 525° C., 530° C., 535° C., 540° C., 545° C., 550° C., 555° C., 560° C., 565° C., 570° C., 575° C., 580° C., 585° C., 590° C., 595° C., 600° C., 605° C., 610° C., 615° C., 620° C., 625° C., 630° C., 635° C., 640° C., 645° C., 650° C., 655° C., 660° C., 665° C., 670° C., 675° C., 680° C., 685° C., 690° C., 695° C., 700° C., 705° C., 710° C., 715° C., 720° C., 725° C., 730° C., 735° C., 740° C., 745° C., 750° C., 755° C., 760° C., 765° C., 770° C., 775° C., 780° C., 785° C., 790° C., 795° C., 800° C., 805° C., 810° C., 815° C., 820° C., 825° C., 830° C., 835° C., 840° C., 845° C., 850° C., 855° C., 860° C., 865° C., 870° C., 875° C., 880° C., 885° C., 890° C., 895° C., 900° C., 905° C., 910° C., 915° C., 920° C., 925° C., 930° C., 935° C., 940° C., 945° C., 950° C., 955° C., 960° C., 965° C., 970° C., 975° C., 980° C., 985° C., 990° C., 995° C., 1000° C., 1005° C., 1010° C., 1015° C., 1020° C., 1025° C., 1030° C., 1035° C., 1040° C., 1045° C., 1050° C., 1055° C., 1060° C., 1065° C., 1070° C., 1075° C., 1080° C., 1085° C., 1090° C., 1095° C., 1100° C., 1105° C., 1110° C., 1115° C., 1120° C., 1125° C., 1130° C., 1135° C., 1140° C., 1145° C., 1150° C., 1155° C., 1160° C., 1165° C., 1170° C., 1175° C., 1180° C., 1185° C., 1190° C., 1195° C., 1200° C., 1205° C., 1210° C., 1215° C., 1220° C., 1225° C., 1230° C., 1235° C., 1240° C., 1245° C., 1250° C., 1255° C., 1260° C., 1265° C., 1270° C., 1275° C., 1280° C., 1285° C., 1290° C., 1295° C., 1300° C., 1305° C., 1310° C., 1315° C., 1320° C., 1325° C., 1330° C., 1335° C., 1340° C., 1345° C., 1350° C., 1355° C., 1360° C., 1365° C., 1370° C., 1375° C., 1380° C., 1385° C., 1390° C., 1395° C., 1400° C., 1405° C., 1410° C., 1415° C., 1420° C., 1425° C., 1430° C., 1435° C., 1440° C., 1445° C., 1450° C., 1455° C., 1460° C., 1465° C., 1470° C., 1475° C., 1480° C., 1485° C., 1490° C., 1495° C., 1500° C., 1505° C., 1510° C., 1515° C., 1520° C., 1525° C., 1530° C., 1535° C., 1540° C., 1545° C., 1550° C., 1555° C., 1560° C., 1565° C., 1570° C., 1575° C., 1580° C., 1585° C., 1590° C., 1595° C., and 1600° C.

The hydrogen generated by the reaction of the hydrocarbon gas feedstock and the silicon powder is discharged from the reactor 16 in hydrogen discharge line 20, and flows to the hydrogen purification unit 24, in which any residual impurities in the hydrogen product gas may be removed to a desired extent in order to yield purified hydrogen product gas, which is discharged from the hydrogen purification unit 24 in hydrogen product discharge line 26. The purified hydrogen product gas discharged in hydrogen product discharge line 26 may be flowed to packaging facilities (not shown) in which the purified hydrogen gas may be packaged in suitable containers, e.g., conventional gas cylinder storage and dispensing vessels, fuel-cell reservoirs, or other containers, or alternatively the purified hydrogen gas may be flowed to a hydrogen delivery pipeline, to a hydrogen liquefaction facility or plant, or blended into natural gas pipelines, or to any other disposition and/or use equipment or facilities (“H₂ Product”).

In other embodiments of the present disclosure, the hydrogen generated by the reaction may be used “as is” in any of a number of use applications. These may include, without limitation, injecting the hydrogen gas into a natural gas turbine to reduce the overall CO₂ footprint of the power generation, blending the hydrogen gas in an existing natural gas pipeline, and utilizing the hydrogen gas for chemical reactions, for example in the production of methanol, and the production of synthetic fuels such as diesel and jet fuel.

The hydrogen product, when purified prior to further use, may be purified in a hydrogen purification unit of any suitable type. The hydrogen purification unit may for example include equipment for membrane purification, physical adsorbent purification, chemisorbent purification, electrochemical purification, and/or other purification operations. For example, an electrochemical purification apparatus may be employed such as the solid-state compressor apparatus described in the aforementioned International Publication WO 2020/016153 A1. Electrochemical purification apparatus is advantageous for compressing hydrogen to very high pressures, such as are typically required for high purity hydrogen delivery. As another example, a membrane purification apparatus may be employed that is permselective for hydrogen but effective for removing trace impurities such as carbon oxides. When sorbent materials are utilized in the hydrogen purification unit for hydrogen purification, such as in a dry scrubber unit containing a bed of the sorbent material, the sorbent material is advantageously highly selective for all relevant impurities of the hydrogen that is discharged by the reactor, and for such purpose, the sorbent material may comprise a mixture of sorbent media, or sequential beds of the respective sorbents, wherein each sorbent is specifically selective for one or more impurity components of the reaction product gas.

Purification equipment and techniques may be employed in the hydrogen purification unit that are of a similar general character to those of the sulfur guard unit (impurity removal unit) 12 previously described, i.e., utilizing single or multiple bed adsorption systems, for PSA, TSA, or PSA/TSA operation, or any other equipment and techniques that are appropriate to the specific impurity species to be removed from the reaction hydrogen product gas, e.g., carbon oxides, ethane, ethylene, acetylene and other hydrocarbons.

Hydrogen gas produced by the process of the present disclosure in various embodiments may be used as fuel in fuel cells, including for example phosphoric acid fuel cells, proton exchange membrane fuel cells, alkaline fuel cells, or other fuel cells or electrochemical energy generation apparatus.

Although not shown in FIG. 1, a heat exchanger may be deployed between the reactor and the hydrogen purification unit, for heat recovery. For example, the heat exchanger may recover heat from the reaction product gas and transfer such heat to the methane gas being supplied to the reactor, in a correspondingly heat exchange arrangement involving countercurrent heat exchange of the reaction product gas and methane gas feedstock. It will be apparent that heaters and coolers may be employed in the system as desired in order to provide and maintain influent and effluent streams in the system at appropriate temperature conditions for production of the final hydrogen product gas and particulate silicon carbide product.

Any heat required for the reaction can be supplied to the reactor by internally disposed heating elements, or by thermal jacketing of the reactor, or by electrical heating of the reactor preferably using renewable electricity, and/or the methane gas feedstock and silicon particles supplied to the reactor may be heated to appropriate temperature to provide appropriate conditions in the reactor for carrying out the reaction.

The particulate silicon carbide product produced by the reaction is discharged from the reactor 16 in silicon carbide discharge line 22 and may be received by a suitable packaging container, bag, or vessel (“SiC Product”). In this respect, the particulate silicon carbide product may be discharged from the reactor, as solid particles of SiC entrained in a gas stream, which may be flowed to a cyclone separator or degassing chamber in which the gas is separated from the particulate SiC, with the latter being sent to a baghouse and/or filter, or other packaging equipment or facility, and with separated gas being circulated to the hydrogen purification unit 24 (by associated piping, not shown in FIG. 1) and/or recirculated to the reactor (by associated piping, not shown in FIG. 1). A cyclone separator, filter, or other appropriate apparatus, may additionally or alternatively be employed for SiC recovery upstream of the hydrogen purification unit 24, with the gas from the reactor being flowed through the cyclone separator (not shown in FIG. 1) before it enters the hydrogen purification unit, with the cyclone separator, filter, or other apparatus being designed to remove >99% of the particles above 10 μm from the gas, to thereby recover all SiC particulates that are entrained in the discharged hydrogen stream. For particles less than 10 μm, coalescing filters or ‘blowback’ filters may be employed to recover all or substantially all of the solid particles from the discharged hydrogen gas stream.

Although the reaction is variously described herein in reference to reaction of methane in the presence of silicon particles to generate hydrogen gas and particulate silicon carbide, it is to be appreciated that the reaction may be carried out with metals other than silicon to form their respective metal carbides. For example, metals such as molybdenum, tungsten, zirconium, or other suitable metals may be employed in the reaction, in place of silicon.

Thus, the disclosure additionally contemplates a process for production of particulate metal carbide and byproduct hydrogen, comprising reacting hydrocarbon gas in the presence of metal particles to form a particulate metal carbide and byproduct hydrogen, and recovering the particulate metal carbide, e.g., a metal carbide of molybdenum, tungsten, or zirconium.

The reaction may be carried out with a suitable catalyst, to augment the catalytic effect of the silicon or other metal particles employed in such reaction. Catalysts such as nickel, iron, or other suitable transition metal catalyst may be employed, and the catalyst may be a single metal catalyst or alternatively a multi-metal, e.g., binary, or ternary, catalyst. The catalyst may be supported on a suitable support, e.g., comprising silica, alumina, molecular sieve, or other suitable material, and the catalyst may include promoters or other adjuvant components.

The catalyst may be any material that is effective to enhance the catalytic effect of silicon (or other metal) in the reaction and that does not affect the purity of the SiC (or other metal carbide) products, and the byproduct hydrogen. For example, sodium metal could be employed as a catalyst, to react with silicon to form sodium silicide, which can be removed from the reaction product of SiC by hot water washing. Transition metal catalysts such as nickel or iron can be removed as volatile metal carbonyl compounds, by treatment using carbon monoxide (CO) at mild temperatures.

In another aspect of the present disclosure, particulate silicon carbide composites may be formed by incorporation of the particulate silicon carbide in matrix materials that are processed to form the composite, e.g., an organic resin matrix material in which the particulate silicon carbide, produced by reaction of hydrocarbon gas in the presence of silicon particles, is dispersed. As an illustrative example, the particulate silicon carbide may be dispersed in a furfuryl alcohol resin, and the resulting resin/particle mixture may be subjected to further reaction to form vitreous carbon in which the particulate silicon carbide functions as a reinforcement material.

In other embodiments for forming particulate silicon carbide composites, the process of the present disclosure may be carried out, in which hydrocarbon gas is reacted in the presence of silicon particles and other materials, so that composite materials are produced. As an illustrative example, a bicomponent sheath/core fiber may be formed, in which the sheath is formed from silicon particles disposed on a core of a carbon precursor or polymer, e.g., polyacrylic nitrile (PAN), with the reaction of the hydrocarbon gas being conducted in the presence of the bicomponent sheath/core fiber precursor, to form a silicon carbide sheath and carbon core bicomponent fiber.

In various embodiments of the process of the present disclosure, the silicon particles may have purity in a range of from 97% to 99%, e.g., of metallurgical grade purity, and such silicon particles may be subjected to upgrading purification to hire purity levels prior to being introduced to the process of the present disclosure. In other embodiments, the silicon particles may be used in the process of the present disclosure at such metallurgical grade purity. In various embodiments, the process of the present disclosure may be carried out to produce particulate silicon carbide having purity of at least 99%.

In the process of the present disclosure, in various implementations thereof, the reacting may be carried out at pressure in a range of 1 to 60 bar, although the disclosure is not limited thereto.

The process of the present disclosure may be carried out in various embodiments, including in commercial manufacturing operations, in a process system including a rotary reactor to which the silicon particles are introduced for the reacting of the hydrocarbon gas in the presence of the silicon particles. The process conducted in such system may comprise repeated cycles of charging the hydrocarbon gas to the rotary reactor containing the silicon particles, reacting the hydrocarbon gas in the presence of the silicon particles in the rotary reactor, and discharge of hydrogen gas from the rotary reactor, with the cycles being followed by reaction to form β-SiC. In such process, the reacting may be carried out at temperature in a range of from 500° C. to 1,100° C., and the reaction to form β-SiC may be carried out at temperature in a range of from 1100° C. to 1500° C. Such process implementation is illustrative of the potential commercial application of the process of the present disclosure, in specific embodiments, but the disclosure is not limited thereto.

It will therefore be appreciated that the silicon carbide production process and system of the present disclosure may be embodied in a variety of specific implementations and methodologies, and associated equipment and apparatus configurations, within the scope of the preceding disclosure.

The features and advantages of the process of the present disclosure are more fully understood and appreciated from the following illustrative and non-limiting examples.

### Example 1

Two grams of silicon powder (99+%, −325 mesh; CAS: 7440-21-3, Acros organics) were placed into a ceramic crucible boat and loaded into a tube furnace. CH₄ gas was fed into the furnace at a rate of 1 mL/min for 30 minutes to flush out any air present in the reaction chamber. Then, the furnace was heated to 1300° C. with a ramping rate of 20° C./min for 12 hours. Several final temperature settings were run to determine the effect of final temperature on SiC formation. During this process, the exit gas stream composition was measured and only CH₄ and H₂ were detected by a gas chromatograph.

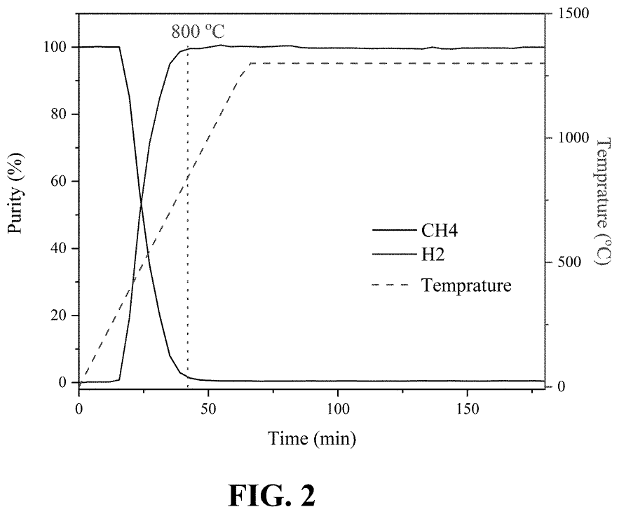

FIG. 2 shows that at an onset temperature of 800° C., CH₄ reaction became complete and almost 100% pure H₂ was produced. At temperatures higher than this onset temperature, only H₂ (and no CH₄) was present in the exit stream.

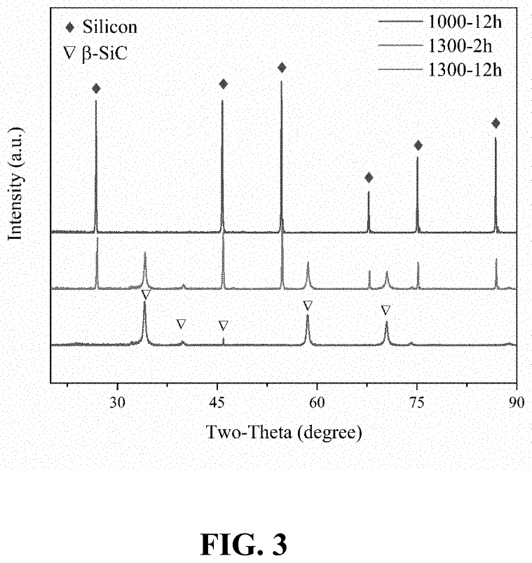

FIG. 3 shows x-ray diffraction (XRD) spectra of SiC formed at two different temperatures and reaction durations. When Si was reacted with CH₄ at 1,300° C. for 12 hours, complete Si conversion to SiC was observed. With 2 hours reaction duration, partial Si conversion to SiC was observed. At 1,000° C., no SiC formation was observed at 12 hours reaction time. It was observed that both Si and SiC appeared to catalyze CH₄ reaction to produce pure H₂.

### Example 2

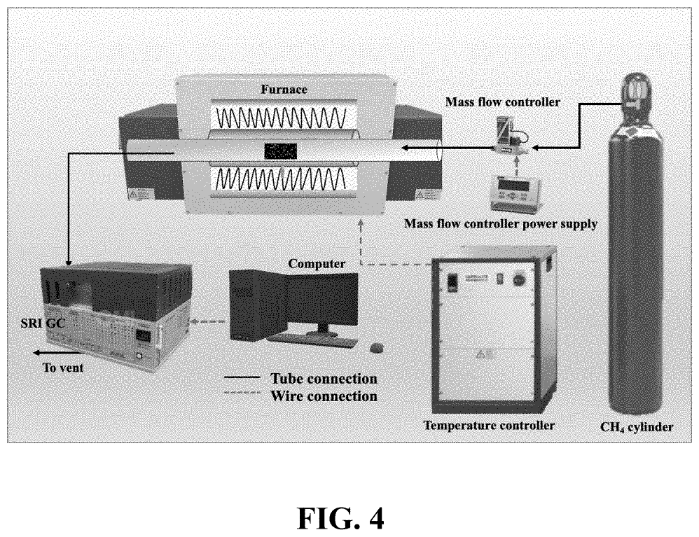

To confirm the benefit of silicon as a catalyst to produce carbon free hydrogen, two experiments were performed under the same reaction conditions. The first experiment was carried out with no Si particles present (blank), and the second experiment was performed with silicon particles. The reactor had an inner diameter (ID) of 25 mm, a length of 250 mm, and was constructed of high-purity alumina, as shown in FIG. 4. At the start of the reaction, the reactor was purged with methane at a flowrate of 100 mL/min until only methane was observed at the outlet by a gas chromatograph (GC). In both experiments, the flowrate of methane was 10 mL/min throughout the reaction process. The temperature of the reactor was ramped at 20° C./minute to 1,300° C. In the second experiment, 0.1003 g of silicon particles (99.2 wt %, d₉₀<5 μm, RESITEC™ 1M micronized silicon powder) was loaded on a sample holder, also made of high-purity alumina.

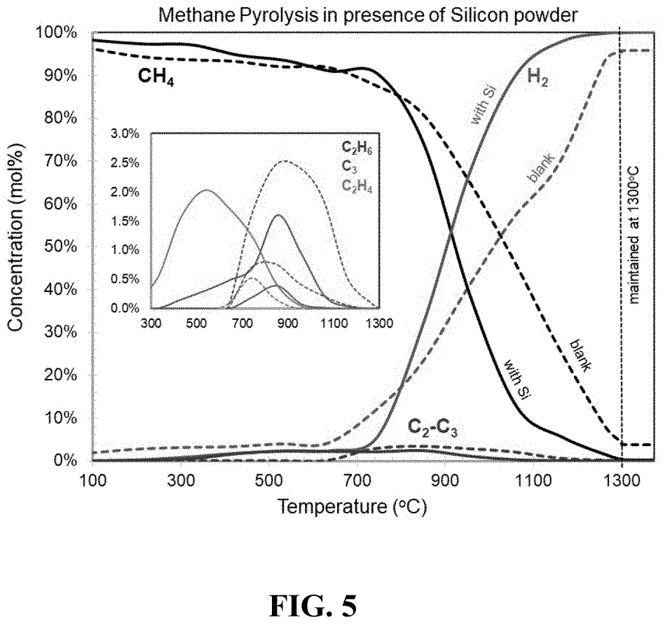

FIG. 5 shows the results of the experiments, in the graph of the composition of the gases exiting the reactor as a function of time, for the first experiment (“blank”) and the second experiment (“with Si”). The results show the beneficial effect of silicon powder on the reaction of methane to form pure hydrogen. The hydrogen purity that was achieved in the “with Si” experiment was several percentage points higher than that produced in the “blank” experiment, and at a significantly lower temperature in the “with Si” experiment than in the “blank” experiment.

### Example 3

In a commercial embodiment, 3,800 kg of Si particles are loaded into a 7 m³ rotary reactor which is closed and sealed. The reactor is purged with argon and/or a vacuum is pulled to remove unwanted nitrogen and oxygen components below detectable levels in the reactor. Methane gas is fed into the reactor at ambient temperature until the pressure reaches a desired level between 1 and 60 bar and the temperature is increased to the desired reaction temperature, e.g., between 500° C. and 1,100° C. The reaction takes place in a time period of approximately 2 to 60 seconds, e.g., after about 30 seconds, with H₂ gas being formed in the free space in the reactor and carbon being deposited on the Si particles. Upon completion of the reaction, the H₂ gas is swept from the reactor with additional methane gas until the concentration of H₂ at the outlet is below 10 vol %, and more preferably is below 1 vol %, whereupon the outlet valve of the reactor is closed. The inlet valve controlling the flow of methane into the reactor is closed once the desired pressure is reached, and the reaction step is repeated. This cycle of reaction (sweep, pressurization, reaction) is repeated 120 times or more, to deposit sufficient carbon onto the Si particles for complete conversion of Si to SiC. The reactor can be rotated after each cycle, or alternatively throughout the entire cycle, to ensure sufficient mixing of Si and C particles.

Following the above-described cycle, the temperature of the reactor is increased to SiC conversion temperatures (between 1,100° C. and 1,500° C.) in which the Si+C solid mixture reacts to form 4,900 kg of beta-SiC. Any excess carbon can be removed by oxidation and vented to the atmosphere, or it can be removed by electrostatic precipitation to be sold as a co-product or otherwise utilized. The entire process takes approximately one day to complete.

The gas mixture is sent to an electrochemical hydrogen purification and compressor (EHC/P) separation device. The H₂ gas exiting the EHC/P apparatus is ready to be sold, having a pressure of 350 bar and purity greater than 99.999%. A second stream exiting the EHC/P apparatus contains residual methane and a small amount of H₂ which can be recycled to the reactor. Storage tanks at the outlet of the EHC/P apparatus receive the high pressure, high purity hydrogen acting as a storage buffer for providing a continuous flow of H₂ or as storage reservoirs for transportation offsite of the production facility.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

1. A process for production of silicon carbide and hydrogen, comprising:
reacting hydrocarbon gas in the presence of silicon particles to form particulate silicon carbide and hydrogen gas; and
recovering the particulate silicon carbide.

2. The process of claim 1, wherein the hydrocarbon gas comprises any one or more gas selected from the group consisting of C₁-C₄ alkanes, C₂-C₄ alkenes, and C₂-C₄ alkynes.

3. (canceled)

4. The process of claim 1, wherein the hydrocarbon gas comprises methane.

5. The process of claim 1, wherein purity of the hydrocarbon gas is at least 1N (90%) purity, at least 2N (99%) purity, at least 3N (99.9%) purity, at least 4N (99.99%) purity, or at least 5N (99.999%) purity.

6. (canceled)

7. The process of claim 1, wherein purity of the hydrocarbon gas is at least 5N (99.999%) purity.

8.-15. (canceled)

16. The process of claim 1, wherein purity of the silicon particles is at least 1N (90%), at least 2N (99%), at least 3N (99.9%), at least 4N (99.99%), or at least 5N (99.999%) purity.

17. (canceled)

18. The process of claim 1, wherein purity of the silicon particles is at least 4N (99.99%) purity.

19. The process of claim 1, wherein purity of the hydrocarbon gas is at least 5N (99.999% purity, and wherein purity of the silicon particles is at least 5N (99.999%).

20.-22. (canceled)

23. The process of claim 1, wherein the reacting is carried out at temperature in a range of from 700° C. to 2200° C.

24. The process of claim 1, wherein the reacting comprises reaction at temperature of at least 1000° C. but below the melting point of silicon in the process, to form the particulate silicon carbide, wherein the particulate silicon carbide comprises β-SiC.

25. The process of claim 1, wherein the reacting comprises reaction at temperature in a range of from 1800° C. to 2500° C., to form the particulate silicon carbide, wherein the particulate silicon carbide comprises α-SiC.

26.-34. (canceled)

35. The process of claim 1, wherein the amount of silicon particles in the reacting is a full stoichiometric amount in relation to the amount of hydrocarbon gas in the reacting.

36. The process of claim 1, wherein the amount of silicon particles in the reacting is less than a full stoichiometric amount in relation to the amount of hydrocarbon gas in the reacting.

37.-39. (canceled)

40. The process of claim 1, wherein the reacting is carried out at temperature in a range in which the lower end point of the range and the upper end point of the range are selected from among the following temperature values, wherein the upper end point of the range is higher than the lower end point of the range: 250° C., 255° C., 260° C., 265° C., 270° C., 275° C., 280° C., 285° C., 290° C., 295° C., 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., 475° C., 480° C., 485° C., 490° C., 495° C., 500° C., 505° C., 510° C., 515° C., 520° C., 525° C., 530° C., 535° C., 540° C., 545° C., 550° C., 555° C., 560° C., 565° C., 570° C., 575° C., 580° C., 585° C., 590° C., 595° C., 600° C., 605° C., 610° C., 615° C., 620° C., 625° C., 630° C., 635° C., 640° C., 645° C., 650° C., 655° C., 660° C., 665° C., 670° C., 675° C., 680° C., 685° C., 690° C., 695° C., 700° C., 705° C., 710° C., 715° C., 720° C., 725° C., 730° C., 735° C., 740° C., 745° C., 750° C., 755° C., 760° C., 765° C., 770° C., 775° C., 780° C., 785° C., 790° C., 795° C., 800° C., 805° C., 810° C., 815° C., 820° C., 825° C., 830° C., 835° C., 840° C., 845° C., 850° C., 855° C., 860° C., 865° C., 870° C., 875° C., 880° C., 885° C., 890° C., 895° C., 900° C., 905° C., 910° C., 915° C., 920° C., 925° C., 930° C., 935° C., 940° C., 945° C., 950° C., 955° C., 960° C., 965° C., 970° C., 975° C., 980° C., 985° C., 990° C., 995° C., 1000° C., 1005° C., 1010° C., 1015° C., 1020° C., 1025° C., 1030° C., 1035° C., 1040° C., 1045° C., 1050° C., 1055° C., 1060° C., 1065° C., 1070° C., 1075° C., 1080° C., 1085° C., 1090° C., 1095° C., 1100° C., 1105° C., 1110° C., 1115° C., 1120° C., 1125° C., 1130° C., 1135° C., 1140° C., 1145° C., 1150° C., 1155° C., 1160° C., 1165° C., 1170° C., 1175° C., 1180° C., 1185° C., 1190° C., 1195° C., 1200° C., 1205° C., 1210° C., 1215° C., 1220° C., 1225° C., 1230° C., 1235° C., 1240° C., 1245° C., 1250° C., 1255° C., 1260° C., 1265° C., 1270° C., 1275° C., 1280° C., 1285° C., 1290° C., 1295° C., 1300° C., 1305° C., 1310° C., 1315° C., 1320° C., 1325° C., 1330° C., 1335° C., 1340° C., 1345° C., 1350° C., 1355° C., 1360° C., 1365° C., 1370° C., 1375° C., 1380° C., 1385° C., 1390° C., 1395° C., 1400° C., 1405° C., 1410° C., 1415° C., 1420° C., 1425° C., 1430° C., 1435° C., 1440° C., 1445° C., 1450° C., 1455° C., 1460° C., 1465° C., 1470° C., 1475° C., 1480° C., 1485° C., 1490° C., 1495° C., 1500° C., 1505° C., 1510° C., 1515° C., 1520° C., 1525° C., 1530° C., 1535° C., 1540° C., 1545° C., 1550° C., 1555° C., 1560° C., 1565° C., 1570° C., 1575° C., 1580° C., 1585° C., 1590° C., 1595° C., and 1600° C.

41.-50. (canceled)

51. The process of claim 1, in which the reacting is carried out in the presence of a catalyst augmenting a catalyst effect of the silicon particles.

52. The process of claim 51, wherein the catalyst comprises a transition metal or metals.

53.-54. (canceled)

55. The process of claim 51, wherein the catalyst comprises alkali metal.

56. The process of claim 55, wherein said alkali metal comprises sodium.

57. The process of claim 1, wherein the silicon particles have an average particle size in a range of from 0.1 μm to 1 mm.

58.-68. (canceled)

69. The process of claim 1, wherein the reacting is carried out at pressure in a range of 1 to 60 bar.

70.-131. (canceled)
